(19) United States
(12) Patent Application Publication
(10) Pub. No.: US 2012/0081126 A1
(43) Pub. Date: Apr. 5, 2012

(54) BATTERY MONITORING SYSTEM WITH A SWITCHING MODE TOPOLOGY

(76) Inventors: Stefan MAIREANU, Sunnyvale, CA (US); William DENSHAM, Los Gatos, CA (US); Jiun Heng GOH, Sunnyvale, CA (US); Flavius LUPU, San Jose, CA (US); Constantin BUCUR, Sunnyvale, CA (US)

(21) Appl. No.: 12/895,024

(22) Filed: Sep. 30, 2010

(51) Int. Cl. G01N 27/416

(52) U.S. Cl. 324/433

(57) ABSTRACT

A battery monitoring system for a battery including multiple battery cells is disclosed. The battery monitoring system includes multiple first switch sets coupled across the battery cells respectively, an energy storage element, and a comparator coupled to the energy storage element via a second switch set. The energy storage element samples cell voltages of the battery cells via the first switch sets respectively. The comparator compares a respective cell voltage with a first reference signal to determine whether a fault condition occurs on a respective battery cell. The second switch set and one of the first switch sets are turned on alternately.

### BACKGROUND

A battery including multiple battery cells can be used in various applications, such as laptop computers, electric vehicles (EVs), hybrid electric vehicles (HEVs), and energy storage systems. During operation, a battery cell may undergo a fault condition, e.g., an over-voltage or under-voltage condition, which may cause damage to the battery cell.

FIG. 1 illustrates a block diagram of a conventional battery monitoring system 100 for a battery 110. In FIG. 1, the battery 110 includes multiple battery cells, e.g., 111-112. The battery monitoring system 100 includes multiple filters, e.g., 120 and 122, multiple voltage-to-current converters, e.g., 130 and 132, and multiple comparators, e.g., 140 and 142, to monitor cell voltages of the battery cells 111-112 respectively in a real-time fashion. Each of the voltage-to-current converters 130 and 132 may include an amplifier and a shifter to convert the cell voltage across a respective battery cell to a current. A sensing resistor, e.g., 151 or 153, is coupled to a respective voltage-to-current converter and translates the current to a voltage proportional to the cell voltage across the corresponding battery cell. A corresponding comparator can compare the voltage from the sensing resistor with a reference to determine whether a fault condition such as an over-voltage or under-voltage condition occurs on the corresponding battery cell.

A filter, an amplifier, a level shifter, and a comparator are used to monitor the cell voltage of the corresponding battery cell. Hence, such complex topology increases the power consumption and the cost of the battery monitoring system 100. Additionally, the mismatch of the currents induced by the multiple filters and the sensing resistors may cause a detection error, which adversely affects the accuracy of the battery monitoring system 100.

### SUMMARY

An embodiment of a battery monitoring system for a battery including multiple battery cells is disclosed. The battery monitoring system includes multiple first switch sets coupled across the battery cells respectively, an energy storage element, and a comparator coupled to the energy storage element via a second switch set. The energy storage element samples cell voltages of the battery cells via the first switch sets respectively. The comparator compares a respective cell voltage with a first reference signal to determine whether a fault condition occurs on a respective battery cell. The second switch set and one of the first switch sets are turned on alternately.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of a conventional battery monitoring system for a battery.

FIG. 2 illustrates a block diagram of a battery monitoring system for a battery, in accordance with one embodiment of the present invention.

FIG. 3 illustrates a timing diagram of determining a fault condition, e.g., an over-voltage condition and an under-voltage condition, by a battery monitoring system for a battery, in accordance with one embodiment of the present invention.

FIG. 4 illustrates a flowchart of operations performed by a battery monitoring system for a battery, in accordance with one embodiment of the invention.

FIG. 5 illustrates a flowchart of an over-voltage verification performed by a battery monitoring system for a battery, in accordance with one embodiment of the present invention.

FIG. 6 illustrates a flowchart of an under-voltage verification performed by a battery monitoring system for a battery, in accordance with one embodiment of the present invention.

FIG. 7 illustrates a block diagram showing a battery providing power to an engine in a system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

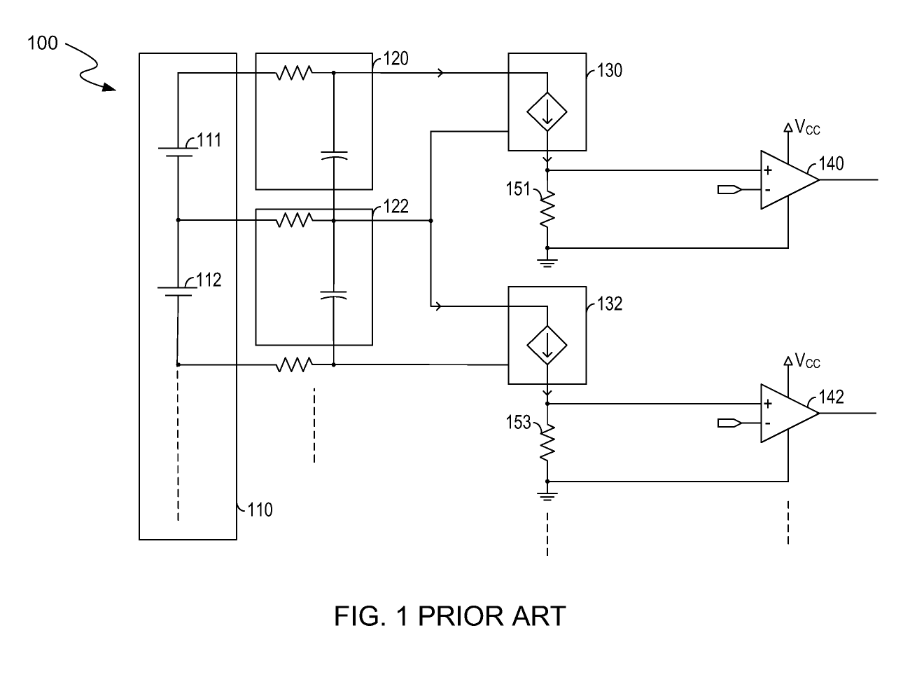

In one embodiment, a battery monitoring system for a battery includes a switch matrix coupled to the battery. The switch matrix includes multiple first switch sets coupled to battery cells in the battery respectively. An energy storage element, e.g., a sampling capacitor, samples cell voltages of the battery cells via the first switch sets respectively. A comparator receives the sampled cell voltages via a second switch set and compares a respective cell voltage with a reference signal to determine whether a fault condition, e.g., an over-voltage condition or an under-voltage condition, occurs on a respective battery cell. The battery cells are protected from the fault conditions and battery lifetime is extended. Compared with the conventional structure in FIG. 1, the battery monitoring system in the present invention has improved power efficiency.

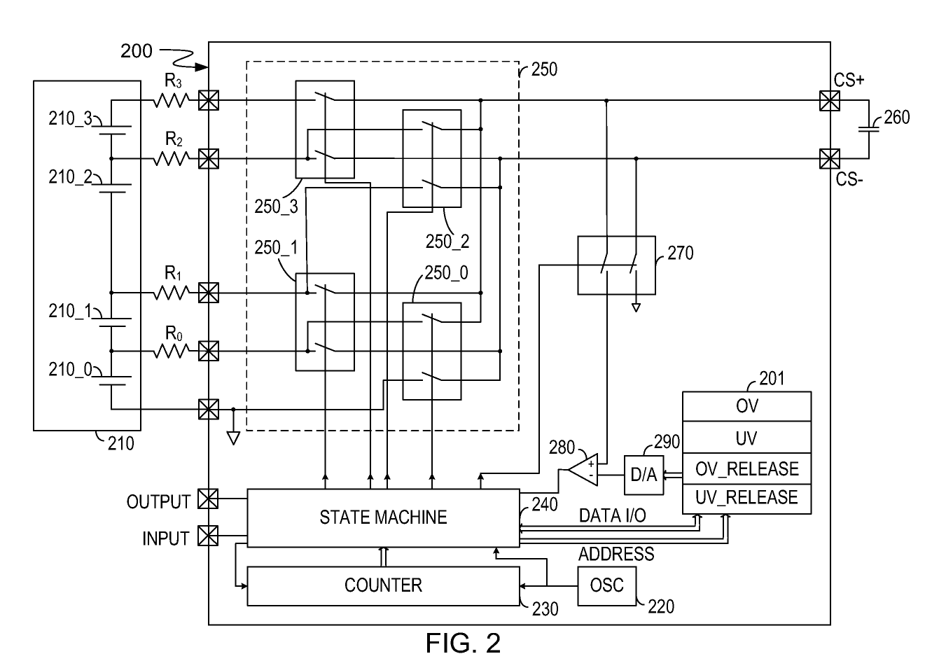

FIG. 2 illustrates a block diagram of a battery monitoring system 200 for a battery 210, in accordance with one embodiment of the present invention. In the example of FIG. 2, the battery 210 includes battery cells 210_0-210_3. However, other number of battery cells can be included in the battery 210.

In one embodiment, the battery monitoring system 200 includes an oscillator 220, a counter 230, and a state machine 240 coupled to the oscillator 220. The oscillator 220 can generate an oscillating signal to drive the counter 230 and the state machine 240. The counter 230 coupled to the state machine 240 calculates the number of pulses in the oscillating signal and controls the state machine 240. A control signal at pin INPUT can control the state machine 240 on or off. The state machine 240 can control a switch matrix 250 and a switch set 270 to sample the cell voltages of the battery cells 210_0-210_3, e.g., sequentially, and to detect whether a fault condition occurs on a respective battery cell 210_0-210_3 according to the corresponding sampled cell voltage.

In the example of FIG. 2, the switch matrix 250 includes multiple switch sets 250_0-250_3. However, other number of switch sets can be included in the switch matrix 250 depending on the number of battery cells. The switch sets 250_0-250_3 are coupled across the battery cells 210_0-210_3 respectively and are coupled to an energy storage element, e.g., a sampling capacitor 260. In the example of FIG. 2, the sampling capacitor 260 is external to the battery monitoring system 200. Alternatively, the sampling capacitor 260 can be integrated in the battery monitoring system 200. Each of the switch sets 250_0-250_3 includes a first switch and a second switch and is controlled by a corresponding control signal from the state machine 240. For example, a positive terminal of the battery cell 210_0 is coupled to a first terminal of the sampling capacitor 260 via the first switch of the switch set 250_0 and pin CS+. A negative terminal of the battery cell 210_0 is coupled to a second terminal of the sampling capacitor 260 via the second switch of the switch set 250_0 and pin CS−. The first switch and the second switch in the switch set 250_0 are controlled by a control signal from the state machine 240. The switch set 270 includes a first switch and a second switch. The first switch of the switch set 270 is coupled between the first terminal of the sampling capacitor 260 and a comparator 280. In one embodiment, the second switch of the switch set 270 is coupled between the second terminal of the sampling capacitor 260 and a terminal for receiving a reference signal. In the example of FIG. 2, the reference signal is ground. The first switch and the second switch in the switch set 270 are controlled by a control signal from the state machine 240.

The state machine 240 turns on the switch set 250_0 and the switch set 270 alternately, in one embodiment. When the switch set 250_0 is turned on and the switch set 270 is turned off, the sampling capacitor 260 can sample the cell voltage of the battery cell 210_0 via the switch set 250_0 and the charges are held in the sampling capacitor 260 for a predetermined duration. Hence, a sample-hold procedure is performed. When the switch set 250_0 is turned off and the switch set 270 is turned on, the battery cell 210_0 is disconnected from the sampling capacitor 260, and the voltage across the sampling capacitor 260 can be sent to the comparator 280 via the switch set 270 to detect whether a fault condition occurs. The current consumption of the switch set 250_0 is determined by a capacitance and a sampling frequency of the sampling capacitor 260 and the cell voltage across the battery cell 210_0. Advantageously, the switch set 250_0 has improved power efficiency.

The state machine 240 can select a predetermined threshold stored in a memory 201 according to an address. The predetermined threshold indicates a fault condition such as an over-voltage condition or an under-voltage condition. In one embodiment, the memory 201 is an electrically erasable programmable read-only memory (EEPROM). The threshold is converted to an analog reference signal by a digital-to-analog (D/A) converter 290. The D/A converter 290 is coupled between the memory 201 and the comparator 280. The state machine 240 performs a comparison procedure after the cell voltage is obtained via the sample-hold procedure. More specifically, the comparator 280 compares the cell voltage of the battery cell 210_0 with the analog reference signal indicating the predetermined threshold to determine whether a fault condition, e.g., an over-voltage or under-voltage condition, occurs on the battery cell 210_0. If a fault condition occurs on the battery cell 210_0, the state machine 240 can inform an external device via pin OUTPUT. If a fault condition does not occur on the battery cell 210_0, the state machine 240 can initiate the sample-hold and comparison procedures for other battery cells 210_1-210_3 individually until all the cell voltages in the battery 210 are detected by the battery monitoring system 200.

Advantageously, the battery monitoring system 200 employs a switching mode topology. The battery monitoring system 200 switches on a corresponding switch set in the switch matrix 250 to sample the cell voltage of the corresponding battery cell and the battery monitoring system 200 further switches on the switch set 270 to compare the sampled cell voltage with a reference signal to prevent the battery cells 210_{—} 0-210 _3 from undergoing fault conditions. Therefore, battery lifetime can be extended. Additionally, the battery monitoring system 200 has improved power efficiency.

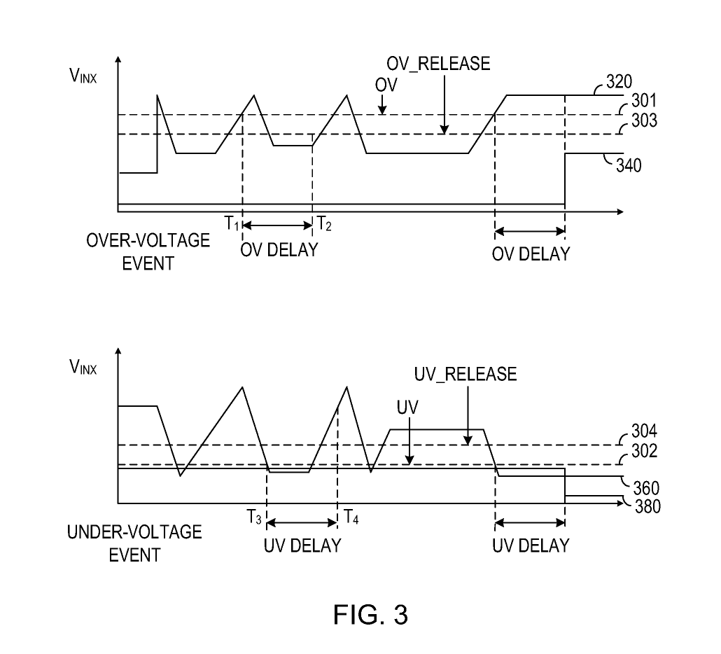

FIG. 3 illustrates an example of a timing diagram of determining a fault condition, e.g., an over-voltage condition and an under-voltage condition by a battery monitoring system, e.g., the battery monitoring system 200, in accordance with one embodiment of the present invention. FIG. 3 is described in combination with FIG. 2.

Waveform 301 illustrates an analog reference signal S_{OV} indicating an over-voltage threshold. Waveform 303 illustrates an analog reference signal S_{OV}_{_{—}}_{RELEASE} indicating an over-voltage release threshold. Waveform 320 illustrates a cell voltage of a battery cell in the battery 210. Waveform 340 illustrates an output signal of the comparator 280, indicating if an over-voltage condition occurs on the battery cell. The cell voltage is compared with the analog reference signal S_{OV} and the analog reference signal S_{OV}_{_{—}}_{RELEASE} by the comparator 280 respectively. In one embodiment, the output of the comparator 280 is logic high, indicating that an over-voltage condition occurs when the cell voltage is greater than the analog reference signal S_{OV} and remains greater than the analog reference signal S_{OV}_{_{—}}_{RELEASE} for a predetermined over-voltage delay period. Otherwise, the output of the comparator 280 is logic low, indicating no over-voltage condition occurs.

Similarly, waveform 302 illustrates an analog reference signal S_{UV} indicating an under-voltage threshold. Waveform 304 illustrates an analog reference signal S_{UV}_{_{—}}_{RELEASE} indicating an under-voltage release threshold. Waveform 360 illustrates a cell voltage of a battery cell in the battery 210. Waveform 380 illustrates an output signal of the comparator 280, indicating if an under-voltage condition occurs on the battery cell. The cell voltage is compared with the analog reference signal S_{UV} and the analog reference signal S_{UV}_{_{—}}_{RELEASE} by the comparator 280 respectively. In one embodiment, the output of the comparator 280 is logic low, indicating that an under-voltage condition occurs when the cell voltage is less than the analog reference signal S_{UV} and remains less than the analog reference signal S_{UV}_{_{—}}_{RELEASE} for a predetermined under-voltage delay period. Otherwise, the output of the comparator 280 is logic high, indicating no under-voltage condition occurs.

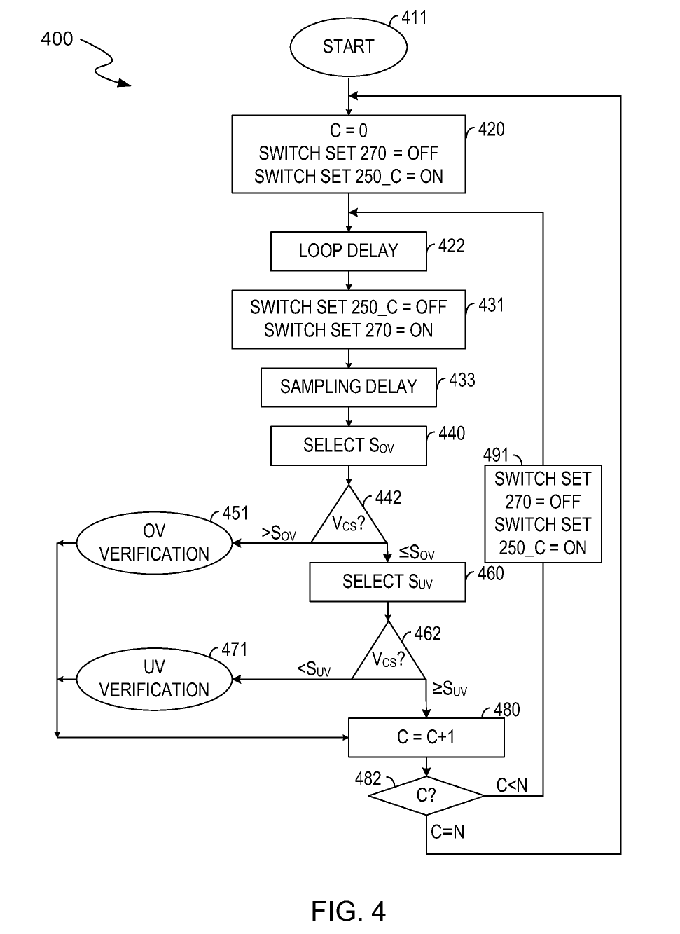

FIG. 4 illustrates a flowchart 400 of operations performed by a battery monitoring system, e.g., the battery monitoring system 200, in accordance with one embodiment of the invention. FIG. 4 is described in combination with FIG. 2 and FIG. 3.

In block 411, the battery monitoring system 200 starts to operate. In block 420, a parameter C is set to an initial value, e.g., 0, by the state machine 240. Under the control of the state machine 240, the switch set 270 is turned off and the switch set 250_C is turned on, in block 420. After a loop delay period, in block 422, the sampling capacitor 260 can sample the cell voltage of the battery cell 210_C via the switch set 250_C and hold the charges indicating the cell voltage V_{CS} for a predetermined period. Thus, a sample-hold procedure is performed.

After the predetermined period expires, controlled by the state machine 240, the switch set 250_C is turned off and the switch set 270 is turned on, in block 431. After a sampling delay period in block 433, the cell voltage V_{CS} is sent to the comparator 280. In block 440, the state machine 240 selects an address of the memory 201 to read an over-voltage threshold according to the address. The over-voltage threshold is converted from a digital signal to an analog reference signal, e.g., the analog reference signal S_{OV} indicating an over-voltage threshold, by the D/A converter 290. In block 442, the cell voltage V_{CS} is compared with the analog reference signal S_{OV} by the comparator 280. If V_{CS} is greater than the analog reference signal S_{OV}, an over-voltage verification is performed, in block 451. If V_{CS} is equal to or less than the first analog reference signal S_{OV}, the state machine 240 selects an address of the memory 201 to read an under-voltage threshold according to the address, in block 460. The under-voltage threshold is converted to an analog reference signal S_{UV} by the D/A converter 290. In block 462, the cell voltage V_{CS} is compared with the analog reference signal S_{UV} by the comparator 280. If V_{CS} is less than the second analog reference signal, an under-voltage verification is performed, in block 471. If V_{CS} is equal to or greater than the second analog reference signal, the parameter C is incremented by 1, in block 480.

In block 482, the parameter C is compared with the total number N of the battery cells in the battery 210. If C is less than N, the state machine 240 turns off the switch set 270 and turns on the switch set 250_C in block 491. The flowchart 400 goes to block 422 such that the sample-hold and comparison procedures are performed for the next battery cell. The sample-hold and comparison procedures are performed for other battery cells individually until the parameter C is equal to N. If the parameter C is equal to N, the flowchart 400 returns to block 420 and the battery monitoring system 200 can start a new cycle to monitor the battery cells.

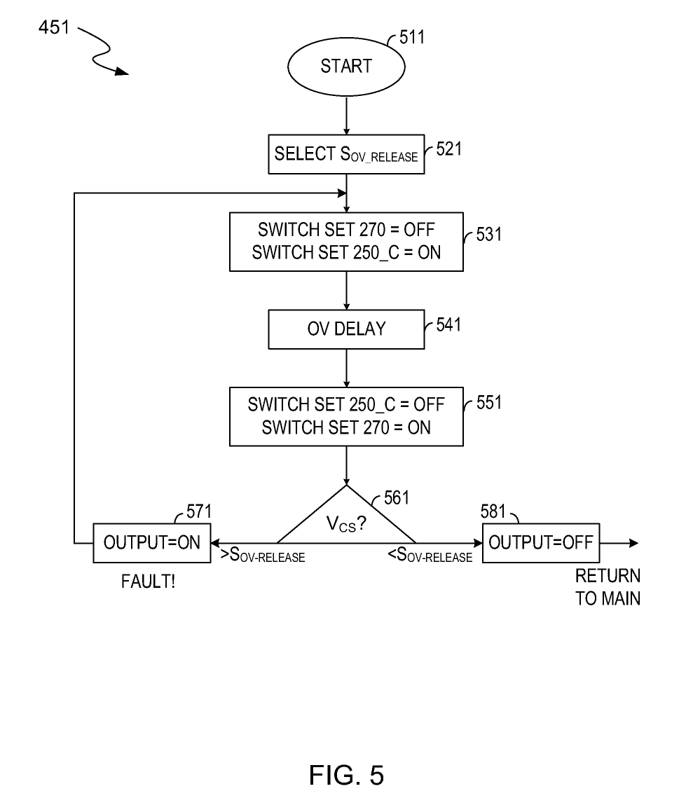

FIG. 5 illustrates an example of a flowchart 451 of an over-voltage verification performed by a battery monitoring system, e.g., the battery monitoring system 200, in accordance with one embodiment of the present invention. FIG. 5 is described in combination with FIGS. 2-4.

In block 511, the over-voltage verification starts to operate. In block 521, the state machine 240 selects an address of the memory 201 to read an over-voltage release threshold according to the address. The over-voltage release threshold is converted to an analog reference signal S_{OV}_{_{—}}_{RELEASE} by the D/A converter 290. In block 531, controlled by the state machine 240, the switch set 270 is turned off and the switch set 250_C is turned on. The sampling capacitor 260 can sample the cell voltage of the battery cell 210_C and hold the charges for a predetermined period. After an over-voltage delay period in block 541, the switch set 250_C is turned off and the switch set 270 is turned on, in block 551. In block 561, the cell voltage V_{CS} is compared with the analog reference signal S_{OV}_{_{—}}_{RELEASE} to determine whether an over-voltage condition occurs. If V_{CS} is greater than the analog reference signal S_{OV}_{_{—}}_{RELEASE}, the state machine 240 can inform an external device that an over-voltage condition occurs on the battery cell 210_C via pin OUTPUT, in block 571. The flowchart 451 then returns to block 531. If V_{CS} is less than the analog reference signal S_{OV}_{_{—}}_{RELEASE}, no over-voltage condition occurs on the battery cell 210_C, in block 581. Then, the flowchart 451 returns to block 480 in FIG. 4 to increment the parameter C by 1.

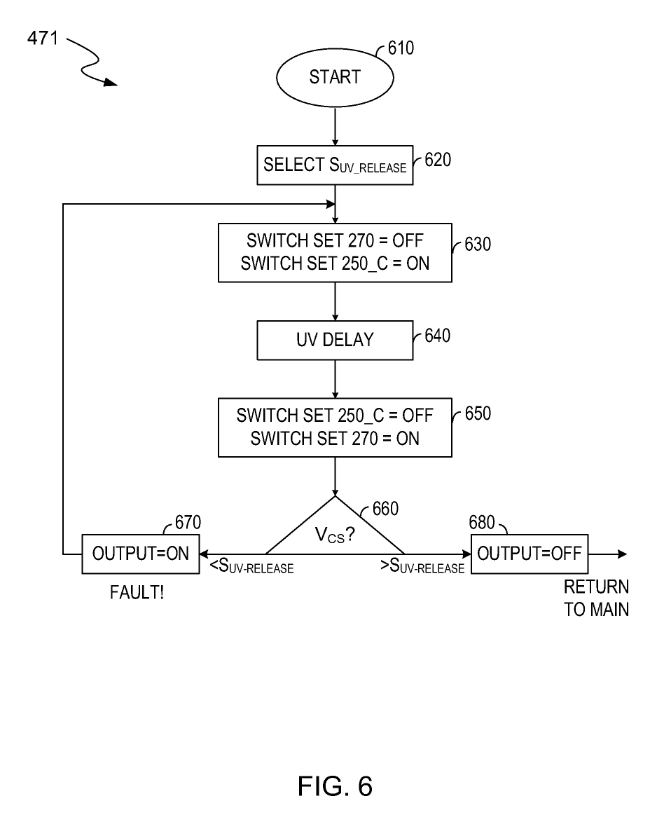

FIG. 6 illustrates an example of a flowchart 471 of an under-voltage verification performed by a battery monitoring system, e.g., the battery monitoring system 200, for a battery, e.g., the battery 210, in accordance with one embodiment of the present invention. FIG. 6 is described in combination with FIGS. 2-4.

In block 610, the under-voltage verification starts to operate. In block 620, the state machine 240 selects an address of the memory 201 to read an under-voltage release threshold according to the address. The under-voltage release threshold is converted to an analog reference signal S_{OV}_{_{—}}_{RELEASE} by the D/A converter 290. In block 630, controlled by the state machine 240, the switch set 270 is turned off and the switch set 250_C is turned on. The sampling capacitor 260 can sample the cell voltage of the battery cell 210_C and hold the charges for a predetermined period. After an under-voltage delay period in block 640, the switch set 250_C is turned off and the switch set 270 is turned on, in block 650. In block 660, the cell voltage V_{CS} is compared with the analog reference signal S_{UV}_{_{—}}_{RELEASE} to determine whether an under-voltage condition occurs. If V_{CS} is less than the analog reference signal S_{UV}_{_{—}}_{RELEASE}, the state machine 240 can inform the external device that an under-voltage condition occurs on the battery cell 210_C via pin OUTPUT in block 670. The flowchart 471 then returns to block 630. If V_{CS} is greater than the analog reference signal S_{UV}_{_{—}}_{RELEASE}, no under-voltage condition occurs on the battery cell 210_C in block 680. Then, the flowchart 471 returns to block 480 in FIG. 4 to increment the parameter C by 1.

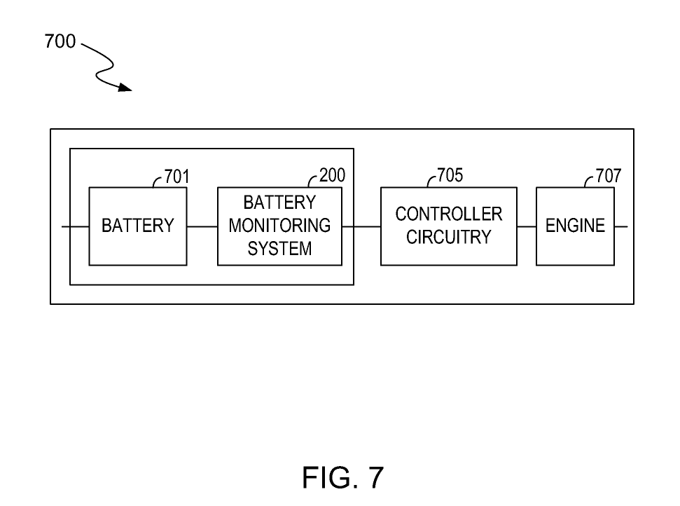

FIG. 7 illustrates a block diagram showing a battery 701 providing power to an engine 707 in a system 700, such as a vehicle, in accordance with one embodiment of the present invention. FIG. 7 is described in combination with FIG. 2-FIG. 6.

In one embodiment, the battery monitoring system 200 and the battery 701 can be integrated into a battery pack. Controller circuitry 705 controls the power from the battery 701 to the engine 707. The battery 701, the battery monitoring system 200, the controller circuitry 705, and the engine 707 are included in the system 700 such as an electric vehicle or a hybrid electric vehicle. Advantageously, the battery monitoring system 200 employs the switching mode topology and sample-hold and comparison technologies to monitor the cell voltages of the battery cells. Hence, the battery 701 can be prevented from undergoing fault conditions. The lifetime of the battery 701 is increased and the reliability of the system 700 is enhanced, which improves the system power efficiency in an electric vehicle or a hybrid electric vehicle and thus reduces pollutants and greenhouse gas emissions and the reliance on fossil fuels.

Accordingly, embodiments in accordance with the present invention provide a battery monitoring system for a battery to determine whether a fault condition occurs on a battery cell in the battery. The battery monitoring system includes multiple first switch sets. The first switch sets are coupled to the battery cells respectively and are coupled to an energy storage element. A state machine is coupled to the first switch sets and a second switch set. In operation, the state machine turns on one of the first switch set and a second switch set alternately. Hence, the energy storage element samples the cell voltages of the battery cells respectively via the first switch sets, holds the charges indicating the cell voltage for a predetermined time, and sends the cell voltage to a comparator via the second switch set. The cell voltage is then compared with one or more thresholds to determine whether a fault condition occurs on a corresponding battery cell.

Advantageously, due to the switching mode topology and sample-hold and comparison technologies used for monitoring the cell voltages of the battery cells, the battery cells are prevented from undergoing fault conditions and battery lifetime is extended. Additionally, the battery monitoring system has improved power efficiency.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A battery monitoring system for a battery comprising a plurality of battery cells, said battery monitoring system comprising:
a plurality of first switch sets coupled across said battery cells respectively;
an energy storage element coupled to said first switch sets and for sampling cell voltages of said battery cells via said first switch sets respectively; and
a comparator coupled to said energy storage element via a second switch set and for comparing a respective cell voltage with a first reference signal to determine whether a fault condition occurs on a respective battery cell,
wherein said second switch set and one of said first switch sets are turned on alternately.

2. The battery monitoring system of claim 1, further comprising:
a state machine coupled to said first switch sets and said second switch set and for turning on said second switch set and said one of said first switch sets alternately, wherein said state machine is further coupled to said comparator and receives a comparison result from said comparator to determine whether said fault condition occurs.

3. The battery monitoring system of claim 2, further comprising:
a memory coupled to said state machine and for storing a threshold indicating said fault condition; and
a digital-to-analog (D/A) converter coupled between said memory and said comparator and for converting said threshold to said first reference signal.

4. The battery monitoring system of claim 2, further comprising:
an oscillator coupled to said state machine and for generating an oscillating signal to drive said state machine; and
a counter coupled to said oscillator and for calculating the number of pulses of said oscillating signal to control said state machine.

5. The battery monitoring system of claim 1, wherein said battery monitoring system detects that said fault condition occurs if said respective cell voltage is greater than said first reference signal and said respective cell voltage remains greater than a second reference signal after a delay period.

6. The battery monitoring system of claim 1, wherein said battery monitoring system detects that said fault condition occurs if said respective cell voltage is less than a third reference signal and if said respective cell voltage remains less than a fourth reference signal after a delay period.

7. The battery monitoring system of claim 1, wherein each of said first switch sets comprises a first switch and a second switch, wherein said first switch is coupled between a positive terminal of said respective battery cell and a first terminal of said energy storage element, and wherein said second switch is coupled between a negative terminal of said respective battery cell and a second terminal of said energy storage element.

8. The battery monitoring system of claim 1, wherein said second switch set comprises a first switch and a second switch, wherein said first switch is coupled between a first terminal of said energy storage element and said comparator, and wherein said second switch is coupled to a second terminal of said energy storage element.

9. A system comprising:
a battery comprising a plurality of battery cells;
a battery monitoring system coupled to said battery and for monitoring cell voltages of said battery cells to determine whether a fault condition occurs on a respective battery cell, wherein said battery monitoring system comprises:
a plurality of first switch sets coupled across said battery cells respectively;
an energy storage element coupled to said first switch sets and for sampling said cell voltages of said battery cells via said first switch sets respectively; and
a comparator coupled to said energy storage element via a second switch set and for comparing a respective cell voltage with a first reference signal to determine whether said fault condition occurs on said respective battery cell, and wherein said second switch set and one of said first switch sets are turned on alternately;
an engine for providing energy to said system; and
controller circuitry coupled between said battery monitoring system and said engine and for controlling power from said battery to said engine.

10. The system of claim 9, wherein said battery monitoring system further comprises:
a state machine coupled to said first switch sets and said second switch set and for turning on said second switch set and said one of said first switch sets alternately, wherein said state machine is further coupled to said comparator and receives a comparison result from said comparator to determine whether said fault condition occurs.

11. The system of claim 10, wherein said battery monitoring system further comprises:
a memory coupled to said state machine and for storing a threshold indicating said fault condition; and
a digital-to-analog (D/A) converter coupled between said memory and said comparator and for converting said threshold to said first reference signal.

12. The system of claim 10, wherein said battery monitoring system further comprises:
an oscillator coupled to said state machine and for generating an oscillating signal to drive said state machine; and
a counter coupled to said oscillator and for calculating the number of pulses of said oscillating signal to control said state machine.

13. The system of claim 9, wherein said battery monitoring system detects that said fault condition occurs if said respective cell voltage is greater than said first reference signal and if said respective cell voltage remains greater than a second reference signal after a delay period.

14. The system of claim 9, wherein said battery monitoring system detects that said fault condition occurs if said respective cell voltage is less than a third reference signal and if said respective cell voltage remains less than a fourth reference signal after a delay period.

15. The system of claim 9, wherein each of said first switch sets comprises a first switch and a second switch, wherein said first switch is coupled between a positive terminal of said respective battery cell and a first terminal of said energy storage element, and wherein said second switch is coupled between a negative terminal of said respective battery cell and a second terminal of said energy storage element.

16. The system of claim 9, wherein said second switch set comprises a first switch and a second switch, wherein said first switch is coupled between a first terminal of said energy storage element and said comparator, and wherein said second switch is coupled to a second terminal of said energy storage element.

17. A method for monitoring a battery comprising a plurality of battery cells, said method comprising:
sampling cell voltages of said battery cells via a plurality of first switch sets respectively by an energy storage element, wherein said first switch sets are coupled across said battery cells respectively and are coupled to said energy storage element;
receiving a respective cell voltage from said energy storage element via a second switch set, wherein said second switch set and one of said first switch sets are turned on alternately; and
comparing said respective cell voltage with a first reference signal to determine whether a fault condition occurs on a respective battery cell.

18. The method of claim 17, further comprising:
accessing a threshold indicating said fault condition from a memory; and
converting said threshold to said first reference signal by a digital-to-analog (D/A) converter.

19. The method of claim 17, wherein said fault condition occurs if said respective cell voltage is greater than said first reference signal and if said respective cell voltage remains greater than a second reference signal after a delay period.

20. The method of claim 17, wherein said fault condition occurs if said respective cell voltage is less than a third reference signal and if said respective cell voltage remains less than a fourth reference signal after a delay period.

21. The method of claim 17, wherein each of said first switch sets comprises a first switch and a second switch, wherein said first switch is coupled between a positive terminal of said respective battery cell and a first terminal of said energy storage element, and wherein said second switch is coupled between a negative terminal of said respective battery cell and a second terminal of said energy storage element.

22. The method of claim 17, wherein said second switch set comprises a first switch and a second switch, wherein said first switch is coupled between a first terminal of said energy storage element and said comparator, and wherein said second switch is coupled to a second terminal of said energy storage element.
